(19) United States
(12) Patent Application Publication
(10) Pub. No.: US 2008/0169934 A1
(43) Pub. Date: Jul. 17, 2008

(54) Portable gas detector

(76) Inventors: Steve Lang, Lawrence, KS (US); Barry Siskind, Henderson, NV (US)

Correspondence Address: SHUGHART THOMSON & KILROY, PC, 120 WEST 12TH STREET, KANSAS CITY, MO, 64105, US

(21) Appl. No.: 11/891,390

(22) Filed: Aug. 10, 2007

Related U.S. Application Data
(60) Provisional application No. 60/838,535, filed on Aug. 11, 2006.

(51) Int. Cl. G08B 17/10

(52) U.S. Cl. 340/632

(57) ABSTRACT

A portable apparatus is provided for detecting the presence in a local atmosphere of gases that are hazardous to the health of humans and animals, the detector providing a warning to the operator of the apparatus of the presence of such gases.

### CROSS REFERENCE TO RELATED APPLICATION

This application claims priority under 35 U.S.C. 119(e) and 37 C.F.R. 1.78(a)(4) based upon copending U.S. Provisional Application Ser. No. 60/838,535 for a Portable Gas Detector filed Aug. 11, 2006 the specification of which is incorporated herein by reference.

### FIELD OF THE INVENTION

The apparatus relates to the detection of low molecular weight gases such as natural gas or LP gas etc. which typically are found in common use in the consumer environment such as a dwelling or in the area of a gas appliance. The present device provides a low cost, portable gas detection unit which may be used by unskilled home owners for the detection of improper gas levels in their environment.

### BACKGROUND OF THE INVENTION

The present-day consumer is frequently confronted with instances of use of LP gas and natural gas in the home and recreational settings, and frequently the LP gas container may be transported from one location to another wherein the LP gas container is subjected to movement or rolling about or other impacts which may affect the integrity of the gas valve stem and other connections related to the LP gas cylinder.

While the most frequent instance of natural gas connections in the home is adjacent the gas water heater or gas furnace, LP gas cylinders are increasingly used to provide a gas source for other combustion devices such as grills or gas heaters or gas powered mosquito killing devices. In summary, the present-day consumer is confronted with a greater variety of uses of natural gas which frequently depend on the portable LP gas cylinder in addition to the historically standard uses of the gas water heater and the gas furnace within the home. Therefore, it is increasingly important that a consumer be able to test natural gas and LP gas cylinders for their integrity and to determine whether or not leakage might be occurring. This issue is particularly important with LP gas cylinders which are refillable and transportable. LP gas cylinders, as mentioned above, are subject to conditions in which impacts against the gas regulator or gas valve stem can occur resulting in the potential for leakage of the gas cylinder. Also, as LP gas cylinders may be used over a long period of time and frequently refilled, the quality or integrity of the seal of the stem and/or shut off valve on the LP gas cylinder should be checked to determine whether the cylinder continues to be leak free over time.

With respect to gas heaters and furnaces and other natural gas fittings within the home, such as those leading to a gas stove, the consumer may believe that they detect the smell of the odorant used in natural gas or LP gas thus becoming concerned about the safety of their in-home natural gas circumstances.

In each of these situations, it would be of benefit if the consumer were able to personally and immediately check the integrity of the seal on these gas fittings and devices without incurring the delay or expense of contacting a plumber or a gas service person to examine the fittings and devices within the home.

It also would be a benefit if a consumer were able to check the seal and the stem and valve condition of an LP gas tank prior to transporting the tank within a closed vehicle. Frequently, a portable LP gas tank must be transported, either for use of the gas tank or for refilling of the gas tank, within a closed vehicle, and the consumer may become subject to olfactory fatigue and be unable to detect the presence of leaking gas within such a confined space. Therefore, the availability of an easily used and portable gas detector would benefit the consumer in these situations.

### SUMMARY OF THE INVENTION

A portable noxious gas detector is provided for detecting noxious gasses and gas mixtures including natural gas (predominately methane and ethane), butane, propane, acetylene and methane gasses. The detector shows a safe condition when the concentration of any noxious gas detected is less than 2000 ppm. A low level gas warning is shown when any noxious gas is detected that is less than 5000 ppm. When a noxious gas concentration is over 5000 ppm, or exceeds 10% of the Lower Explosive Limit (LEL) for the gas, a red alarm condition is shown by the detector. The total range of gas detection for portable gas detector 10 is 0 to 10,000 ppm. The device is operable in a temperature range of minus 14 degrees Fahrenheit to 122 degrees Fahrenheit (minus 10 degrees C.-50 degrees C.).

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a top and front and right side perspective view of the gas detector;

FIG. 2 is a right side view of the embodiment of FIG. 1;

FIG. 3 is a front view of the embodiment of FIG. 1;

FIG. 4 is a top view of the embodiment of FIG. 1;

FIG. 5 is a rear elevation view of the embodiment of FIG. 1;

FIG. 6 is a left side view of the embodiment of FIG. 1;

FIG. 7 is a bottom view of the embodiment of FIG. 1;

FIG. 8 is an exploded view of the embodiment of FIG. 1;

FIG. 9 is a top and front and right side perspective view of the embodiment of FIG. 1 having a protective cap placed over the end of the detector;

FIG. 10 is a right side view of the embodiment of FIG. 1 having a protective cap placed over the end of the detector; and

FIG. 11 is a front view of the embodiment of FIG. 1 having a protective cap placed over the end of the detector.

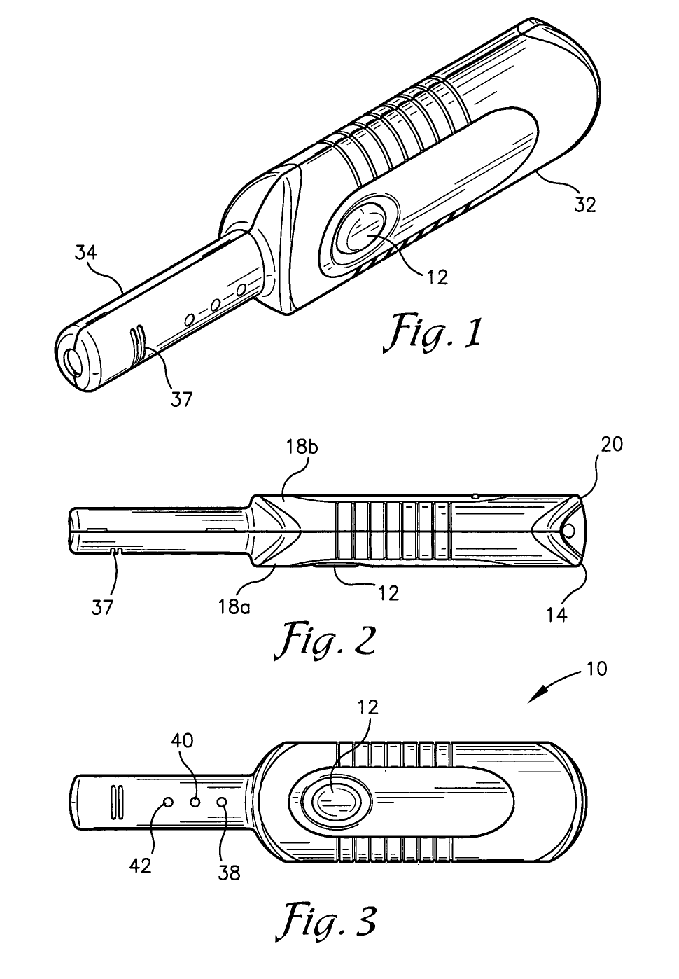

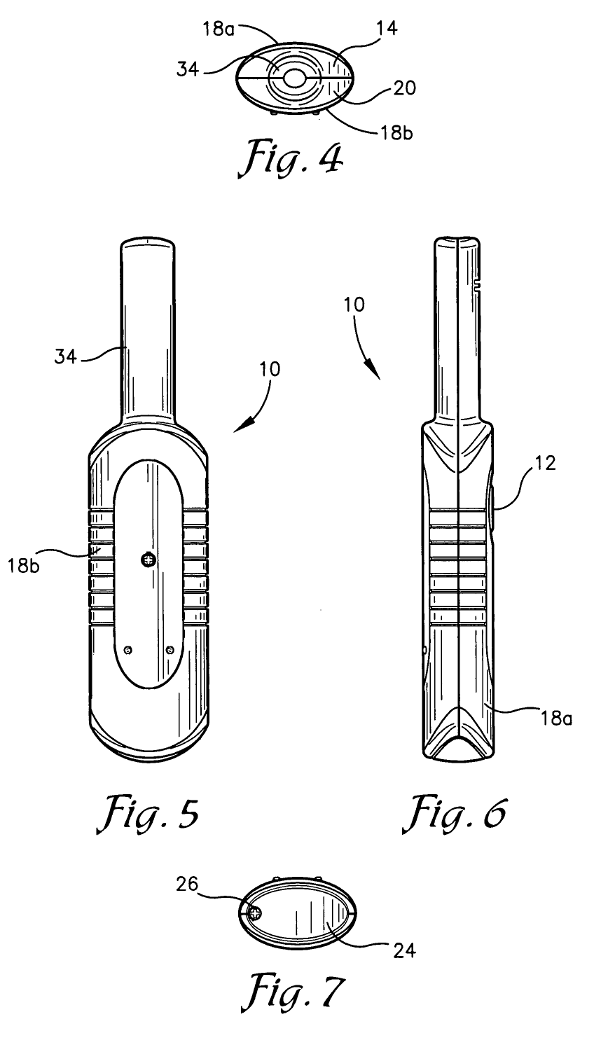

### DESCRIPTION OF THE PREFERRED EMBODIMENT

As required, detailed embodiments are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

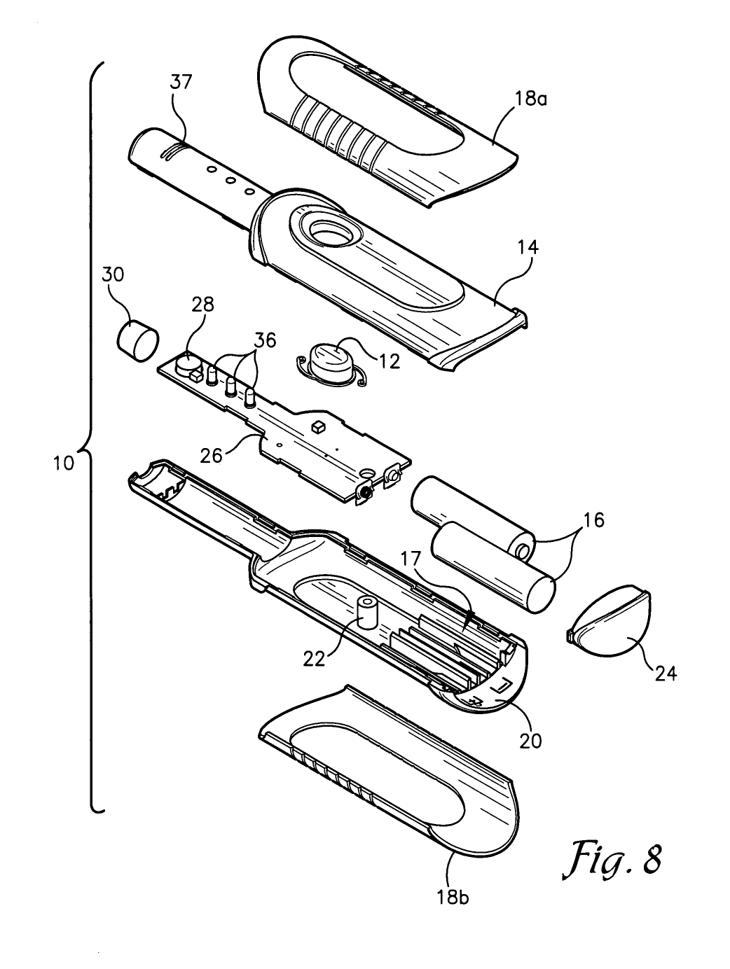

Referring now to FIG. 8, the detector 10 is shown in exploded view and is comprised of the following components. Detector 10 is provided with off/on switch 12 which is seated within top housing portion 14. The user, by depressing off/on switch 12, allows the detection circuits 26 within detector 10 to be powered by batteries 16, which in the preferred embodiment of the present invention, comprise two AAA batteries. Detector 10 is provided with grip 18a connected to top housing portion 14, and grip 18b connected to bottom housing portion 20. Housing portions 14 and 20 are press fitted together and secured together by a screw passing through screw mount 22. Batteries 16 are held within space provided between top housing 14 and bottom housing 20 by battery cover 24. Also secured between top housing 14 and bottom housing 20 is circuit board 26 having detector unit 28 thereon. Intake nozzle 30 is seated within a top portion of top housing 14 and bottom housing 20. It will be appreciated by examination of FIG. 5 that top housing 14 and bottom housing 20 are comprised of a handle portion 32 and a wand portion 34, the handle portion 32 being grasped by the user while manipulating the device and wand portion 34 being directed by the user toward the area of interest for detecting a noxious gas emission in a local atmosphere.

### Preparation of Device for Use

The portable gas detector 10 is available for immediate use once power is provided to the device and short warm-up period is provided for the sensor. To install batteries or to change out batteries, the user removes battery cover 24 by unscrewing a screw fastener 26 (FIG. 7) that holds battery cover 24 in place between top housing 14 and bottom housing 20. The user then removes battery cover 24 to expose the battery chamber 17 which is a void created by the coupling together of top housing portion 14 and bottom housing portion 20. The user then inserts two AAA batteries (1.5 volts each) and secures battery cover 24 in place by use of a screw 26 or by a press fit or frictional fit of cover 24 with top housing portion 14 and bottom housing portion 20 to hold the inserted batteries within handle portion 32 of portable gas detector 10.

### Operation

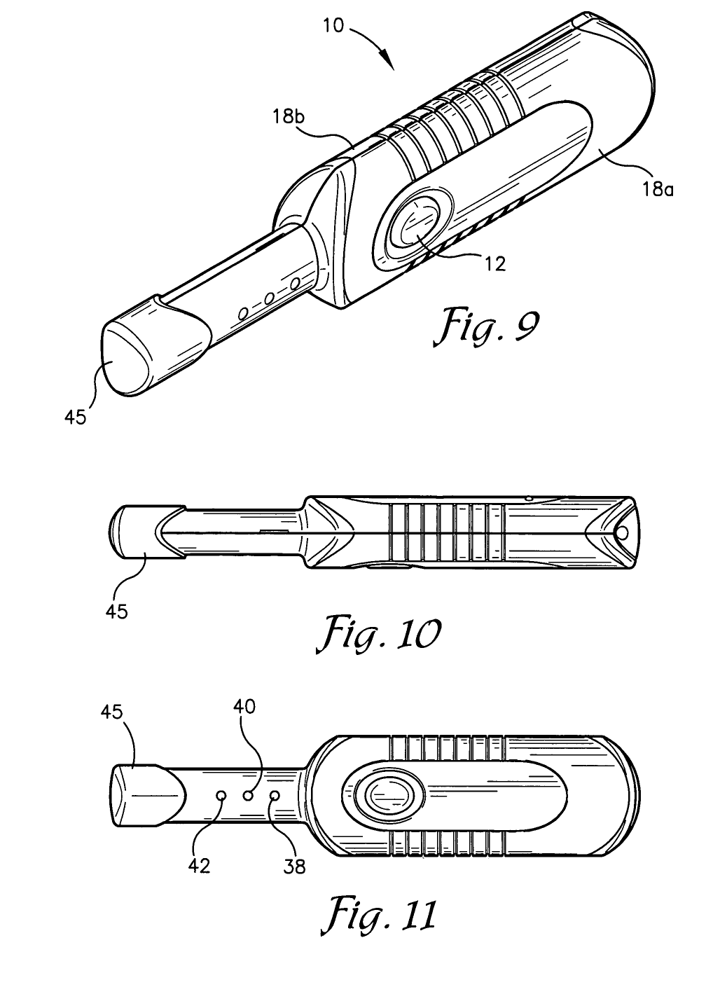

To operate detector 10 a user removes cap 45 (FIG. 9) turns on detector 10 by depressing off/on switch 12 and holding detector 10 in the vicinity of the local atmosphere to be tested for the presence of noxious gasses. A portion of the local atmosphere enters detector 10 through slits 37 (FIG. 8) in wand portion 34 of detector 10.

Portable gas detector 10 is provided with LED signal display 36 (FIG. 8) which is comprised of green LED signal 38 and yellow LED signal 40 and red LED signal 42 (FIG. 3). Green LED 38 serves the purpose of showing that power is being provided to the detector and that the device is on and operational. Green LED 38 also shows a safe condition and is lit when a concentration of any noxious gas detected is at a range of less than 2000 ppm. Portable gas detector 10 also is provided with a yellow LED which is the low level gas warning detection alarm. Yellow LED 40 is activated and glows yellow when any noxious gas is detected that is less than 5000 ppm. When the yellow detector is activated, the consumer should be aware that extraneous noxious gas is present in the local atmosphere and further investigation is necessary. Portable gas detector 10 further is provided with red LED 42 which represents the noxious gas high alarm condition. Red LED 42 glows when the gas concentration detected is over 5000 ppm or exceeds 10% of the Lower Explosive Limit (LEL) for any detectable noxious gas. The user, upon observing a red LED glowing or a high alarm condition, should become immediately concerned and contact an appropriate repair or service person to examine the problem. The user should ventilate the area, if possible, and/or evacuate the area where the noxious gas is detected.

The total range of gas detection of portable gas detector 10 is 0 to 10,000 ppm. The device is operable in a temperature range of minus 14 degrees Fahrenheit to 122 degrees Fahrenheit (minus 10 degrees C.-50 degrees C.). The detector of the present device is sensitive to the noxious gases comprising: natural gas (predominately methane and ethane), butane, propane, acetylene and methane gasses. At the conclusion of use of the device, the off/on switch 12 should be released to terminate powering of the circuit board and detector. The device is then placed in storage at a convenient location for its next use.

The detector uses a semiconductor gas sensor that is designed for detection of flammable gas. As the concentration of gas increases the resistance of the sensor changes. The change in resistance is then electronically detected. A detected change in the resistance of the sensor indicates the presence of a flammable gas in the local atmosphere. The amount of detected change in the resistance of the sensor indicates the concentration of flammable gas that is present.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive Portable Gas Detector is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention, what is claimed as new and desired to be secured by Letters Patent is as follows:

1. An apparatus for detecting the presence of a gas noxious to humans and animals in a local atmosphere comprising:
a housing having a handle portion and a wand portion extending therefrom,
a noxious gas sensor in said wand portion for determining the quantity of a noxious gas in a local atmosphere, the quantity of the noxious gas being in the range of greater than zero parts per million of noxious gas to greater than 10,000 parts per million of noxious gas in the local atmosphere,
a first noxious gas signal,
a second noxious gas signal,
a third noxious gas signal,
a battery for powering said apparatus, and
an off/on switch mounted on said housing for providing power from said batter to said detector and said first, second and third signals.

2. The apparatus as claimed in claim 1 wherein said first noxious gas signal is responsive to an amount of noxious gas of less than approximately 2000 ppm of noxious gas.

3. The apparatus as claimed in claim 1 wherein said second noxious gas signal is responsive to an amount of noxious gas of less than approximately 5000 ppm of noxious gas.

4. The apparatus as claimed in claim 1 wherein said third noxious gas signal is responsive to an amount of noxious gas of greater than approximately 5000 ppm of noxious gas.

5. The apparatus as claimed in claim 1 wherein said noxious gas is methane.

6. The apparatus as claimed in claim 1 wherein said noxious gas is natural gas.

7. The apparatus as claimed in claim 1 wherein said noxious gas is butane.

8. The apparatus as claimed in claim 1 wherein said noxious gas is propane.

9. The apparatus as claimed in claim 1 wherein said noxious gas is acetylene.

10. The apparatus as claimed in claim 1 wherein said noxious gas is ethane.
